(19) United States
(12) Patent Application Publication
(10) Pub. No.: US 2013/0311974 A1
(43) Pub. Date: Nov. 21, 2013

(54) DEBUGGER INTEGRATION OF REPORTING TOOL RENDERER

(71) Applicant: Zoltan Albrecht, Karlsruhe (DE)

(72) Inventor: Zoltan Albrecht, Karlsruhe (DE)

(21) Appl. No.: 13/473,553

(22) Filed: May 16, 2012

(51) Int. Cl. G06F 9/44

(52) U.S. Cl. 717/125

(57) ABSTRACT

A debugging tool for a program includes a display of custom UI components to visually depict external parameters with an internal program state, thus enabling full context information during program debugging. A trace process on a program being executed by a computer is examined by a debugger, which retrieves internal state data of the program being executed. The internal state data is displayed in a first window of a user interface generated by the debugger. A script is then executed by the debugger to interact with the program being executed by the computer, to retrieve a result set associated with external parameters of the program being executed, and display the result set in a second window of the user interface.

### TECHNICAL FIELD

The subject matter described herein relates to debuggers of computer programs, and more particularly to debugger integration of reporting tool renderer.

### BACKGROUND

Users interact with computer programs via human-machine interfaces, using for example a graphical user interface (GUI). Machine response can be made visible for the user again e.g. via the GUI. The input and output parameters exchanged between a user and the computing machine are called external parameters as they define the boundary conditions for the executed program.

Computers are used by most users as a black box meaning that the methods and algorithms leading to the output are not known or are not of interest. That changes drastically if an actual result is different from the expected. In this case a qualified user may want to examine the running program more closely. To do so debuggers can be used. Debuggers are used to illustrate the current command for execution, the values of variables visible within the current scope, the current program stack, etc. In short a debugger displays the internal state of a program at each execution step.

Comparing the internal program state with the external parameters it is possible to follow the steps of the executed algorithms leading to the end result. There are certain scenarios when the external parameters are not known and a program is executed without user interaction. Two examples of such scenarios:

1) The end-user is presented by the computing machine with results that are unexpected or very difficult to interpret or understand. The technical expert in charge of debugging the system is usually not the same as the end-user. The end-user is asked to record the system behavior. The recorded trace is sent to the technical expert who runs the trace and examines the internal states of the program. Given a sufficient complexity of the underlying problem, the expert will need additional information on the corresponding external parameters to judge the validity of the computing results.

2) Complex application programming interfaces (APIs) are shipped alongside with user manuals and ideally with sample coding. Sample coding defines an example client accessing the shipped API. The external parameters and API function calls are stored within the sample coding itself. The external parameters are not visualized on any output device except for the debugger. Again depending on the complexity of the problem and of its parameters, it may be difficult to judge the effect of the parameters on the executed program.

The knowledge of only the internal state of a program is in general not sufficient to judge the validity of its results. The display of the external parameters is in general not always possible. This is true due to the great variety of possible user scenarios or software clients using a specific program.

### SUMMARY

In one aspect, a computer-implemented method includes the steps of examining a trace process on a program being executed by a computer, and retrieving internal state data of the program being executed. The method further includes displaying the internal state data in a first window of a user interface generated by the debugger, executing a script to interact with the program being executed by the computer, to retrieve a result set associated with external parameters of the program being executed, and displaying the result set associated with the external parameters in a second window of the user interface.

In another aspect, a debugging system includes a debugger module executed by at least one data processor, the debugger module examining a trace process on a program being executed by a computer, and retrieving internal state data of the program being executed. The system further includes a scripting framework having at least one script executing, by at least one data processor, the script to retrieve a result set associated with external parameters of the program being executed. The system further includes a renderer to generate a display for a user interface, the display providing a first window to display the internal state data retrieved from the program being executed, and a second window to display the result set associated with the external parameters.

Implementations of the current subject matter can include, but are not limited to, systems and methods, including methods tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIGS. 1A-1C illustrate a system and process for integrating a GUI with external parameters with internal states in a debugger;

FIG. 2 illustrates a screen of a GUI showing integrated external parameters from an end-user GUI and internal states from commands executed by a program; and

FIG. 3 is a flowchart of a method for debugger integration of RSRT renderer.

FIG. 4 illustrates an RSRT framework consistent with implementations of the subject matter described herein.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide a debugging tool for a program, where the debugging tool includes a display of custom UI components to visually depict external parameters with an internal program state, thus enabling full context information during program debugging.

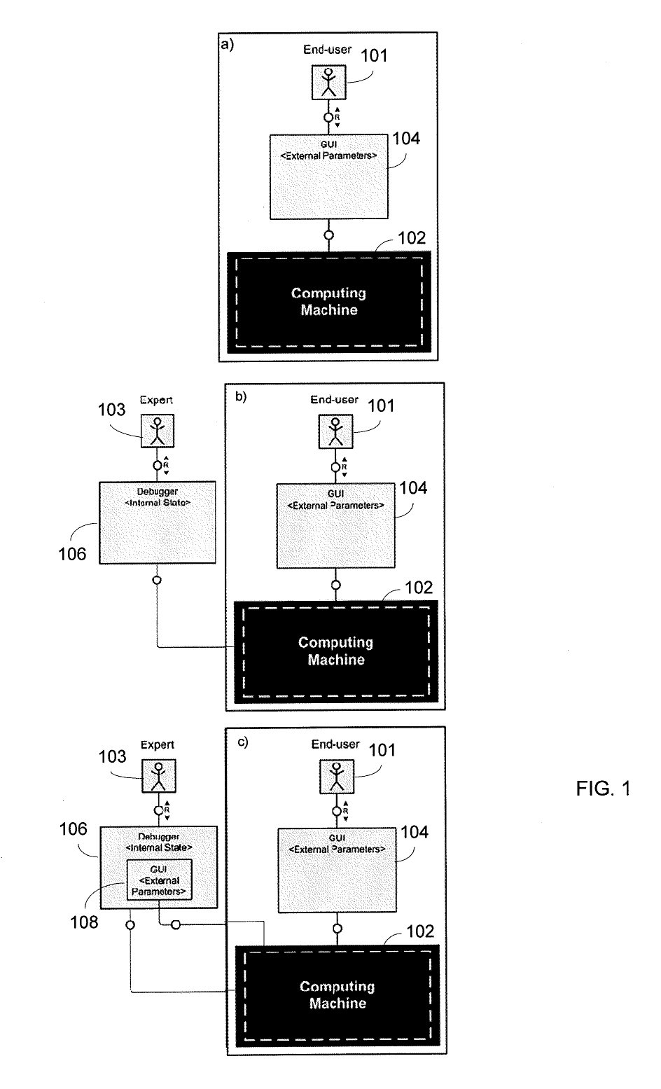

FIGS. 1A-1C illustrate a system and process for integrating a GUI with external parameters with internal states in a debugging tool. FIG. 1A illustrates an access pattern of an end-user 101 to a program executed on a computer 102 or computing machine. The end user 101 uses a graphical user interface (GUI) 104 on a display to see the output of the program, or representation thereof. Depending on the output displayed on the GUI, the user can enter input data into the computer 102. The interaction between the end user 101 and the computer 102 takes place solely via these external parameters.

FIG. 1B illustrates a scenario in which, if the internal state of the executed program is of interest, a dedicated expert 103 can use a debugger 106 to view, step-by-step, every command executed by the computer 102, alongside with all variable values that are made visible in a current context. The external parameters of the program, which are normally provided in the GUI 104, may not be known to the expert 103.

FIG. 1C illustrates an implementation in which the display of the internal program state and of the external parameters are integrated on one GUI screen 108 of the debugger 106, to enable the expert 103 to better judge the validity of program execution by the computer 102. This solution is described in further detail below, in the exemplary context of an analytical engine program running on the computer 102, such as the Analytical Engine of a Business Warehouse (BW) program provided by SAP of Walldorf, Germany.

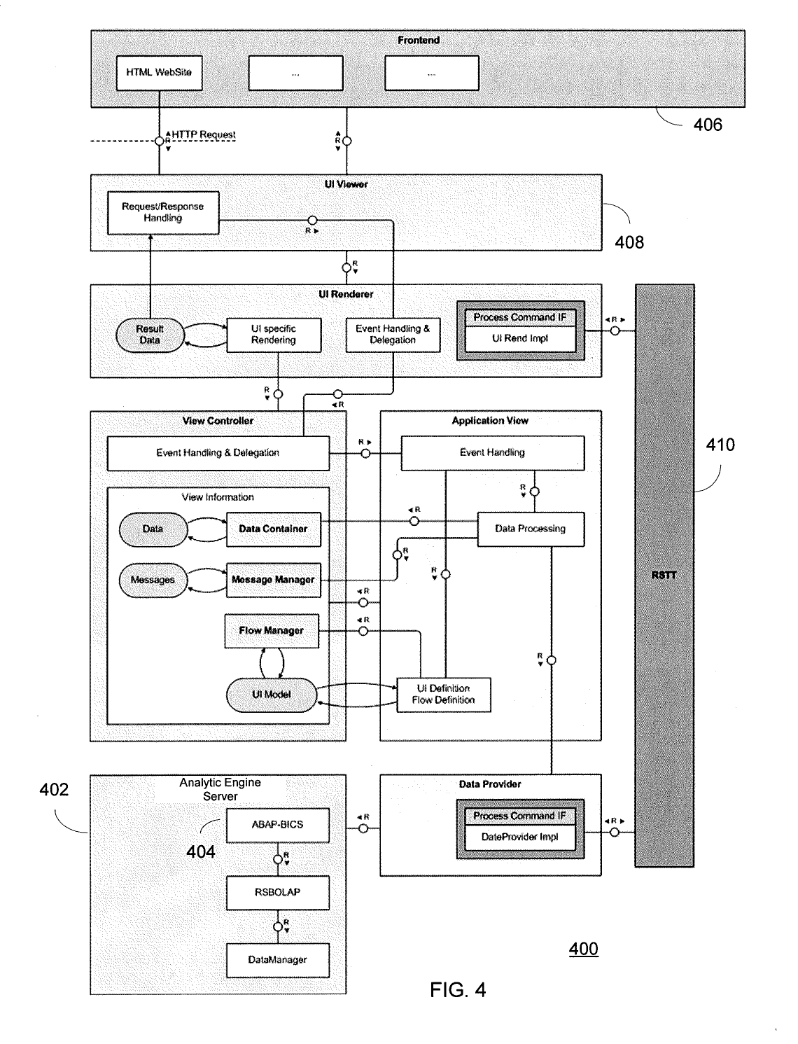

As shown in FIG. 4, which shows a reporting service/reporting tool (RSRT) 400, an analytic engine 402, such as is found in SAP's BW program, can be consumed internally within the program environment via an application programming interface (API) 404, such as ABAP BICS. Clients of the API can be:
front-end layers 406 providing professional UIs 408 to users
local applications of the BW program
remote applications

Users of these clients experiencing an error on an unexpected output can record an output trace file of a reporting service trace tool (RSTT) 410 on the BW server. The trace file contains the sequence of API calls executed by the client, and is used by support experts 103 to debug the execution of the API and of the underlying analytical engine.

The client output is not part of the trace, since it is technically not feasible to be included, and since the clients are all very different and are not necessarily part of the program environment. The execution of the trace alone does not convey enough information to easily judge what the user has executed in the first place, and on the information used in the execution.

The API 404 exposes the features of the analytical engine 402 via a complex object-oriented interface. The use of the complex object-oriented interface is documented for client developers. Additionally the API 404 is shipped together with a complete set of sample client code and query content. Developers can learn the API usage by simply looking at the sample code or executing it and watching the system response in the debugger. However, the results shown in the debugger are very technical and an inexperienced ABAP BICS user will have great difficulty in the interpretation.

Both contexts mentioned above each use the ABAP BICS API 404 to retrieve the Query Result Set by calling a specific method. Using the debugger to stop at the point where the Query Result Set is handed over to the calling application, it is possible to display the result set in a dedicated UI embedded in the debugger.

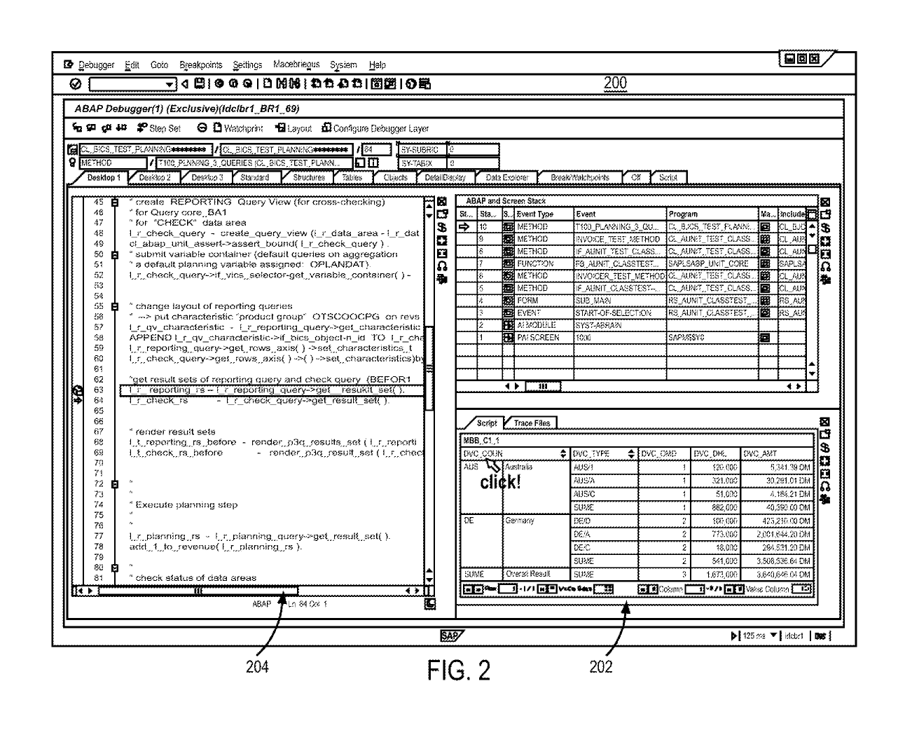

FIG. 2 illustrates a screen 200 of a debugger GUI showing integrated external parameters from an end-user GUI and internal states from commands executed by a program. In some implementations, the debugger executes a custom script from a debugger scripting framework to retrieve the technical result set data from the program being executed and debugged on the computer, and to forward the result set to a rendering engine of the RSRT framework. The RSRT framework 400 is used in the internal test UI to display query result sets. The display container of the debugger scripting framework can be used to play the same role as the normal GUI container of the RSRT transaction.

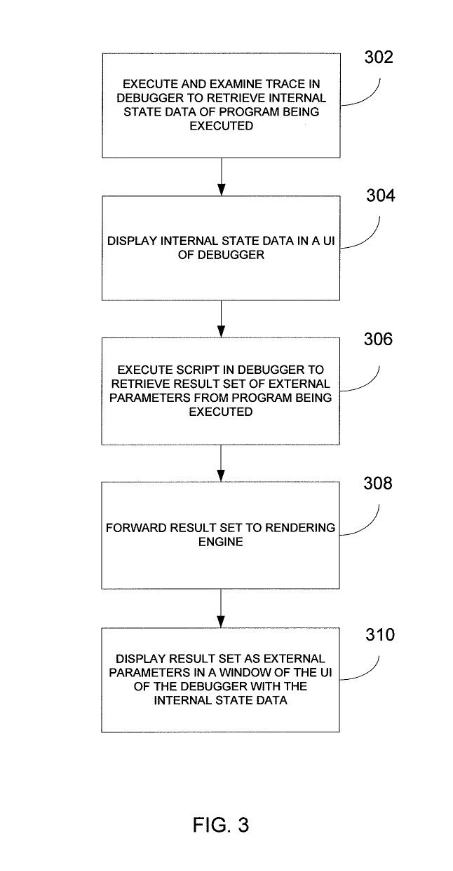

FIG. 3 is a flowchart of a method 300 for integrating internal state data with external parameter result sets in a debugger UI. At 302, a trace program is executed and examined by the debugger to retrieve internal state data of a program being executed. At 304, the internal state data retrieved is displayed in a first window of a UI generated by the debugger. At 306, a script is executed in the debugger to retrieve a result set of external parameters from the program being executed. At 308, the result set is forwarded to a rendering engine in the debugger. At 310, the result set is displayed as external parameters in a second window of the UI of the debugger. In some implementations, the external parameters in the second window of the UI can be coordinated or associated with the internal state data displayed in the first window of the UI.

Accordingly, it is possible to view the result of the API execution and to see the same set of information that was also available to the user recording the RSTT trace. Along with the static result, it is also possible to display the actions executed upon the grid, thus “replaying” the clicks of the user.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
examining, by at least one data processor of a debugger, a trace process on a program being executed by a computer;
retrieving, by at least one data processor of the debugger, internal state data of the program being executed;
displaying the internal state data in a first window of a user interface generated by the debugger; and
executing, by at least one data processor of the debugger, a script to interact with the program being executed by the computer, the script to retrieve a result set associated with external parameters of the program being executed.

2. The method in accordance with claim 1, further comprising:
displaying the result set associated with the external parameters in a second window of the user interface.

3. The method in accordance with claim 2, further comprising:
displaying the result set associated with the external parameters in the second window of the user interface concurrent with the display of the internal state data in the first window of the user interface.

4. The method in accordance with claim 3, wherein the result set associated with the external parameters is displayed as custom user interface (UI) components.

5. The method in accordance with claim 3, wherein displaying the result set associated with the external parameters in the second window of the user interface concurrent with the display of the internal state data in the first window of the user interface further includes associating the external parameters with the internal state data.

6. A debugging system comprising:
a debugger module executed by at least one data processor, the debugger module examining a trace process on a program being executed by a computer, and retrieving internal state data of the program being executed;
a scripting framework having at least one script executing, by at least one data processor, the script to retrieve a result set associated with external parameters of the program being executed; and
a renderer to generate a display for a user interface, the display providing a first window to display the internal state data retrieved from the program being executed, and a second window to display the result set associated with the external parameters.

7. The debugging system in accordance with claim 6, wherein the renderer further generates the display of the internal state data concurrent with the display of the result set associated with the external parameters.

8. The debugging system in accordance with claim 7, wherein the renderer further coordinates the display of the internal state data with the display of the result set associated with the external parameters.

9. The debugging system in accordance with claim 6, wherein the result set associated with the external parameters is displayed as custom user interface (UI) components.

10. The debugging system in accordance with claim 9, wherein the renderer displays the result set associated with the external parameters as the custom UI components.

11. A computer-readable medium containing instructions to configure a processor to perform a method, the method comprising:
examine a trace process on a program being executed by a computer;
retrieving internal state data of the program being executed;
displaying the internal state data in a first window of a user interface; and
executing a script to interact with the program being executed by the computer, the script to retrieve a result set associated with external parameters of the program being executed.

12. The computer-readable medium in accordance with claim 11, further comprising instructions to configure a processor to display the result set associated with the external parameters in a second window of the user interface.

13. The computer-readable medium in accordance with claim 11, further comprising instructions to configure a processor to display the result set associated with the external parameters in the second window of the user interface concurrent with the display of the internal state data in the first window of the user interface.

14. The computer-readable medium in accordance with claim 11, wherein the result set associated with the external parameters is displayed as custom user interface (UI) components.

15. The computer-readable medium in accordance with claim 11, further comprising instructions to configure a processor to associate the external parameters with the internal state data.
